(19) United States
(12) Patent Application Publication
(10) Pub. No.: US 2018/0056578 A1
(43) Pub. Date: Mar. 1, 2018

(54) Surface Texturing Materials With An Ultrasonic Tool

(71) Applicant: GM GLOBAL TECHNOLOGY OPERATIONS LLC, Detroit, MI (US)

(72) Inventors: Ingrid A. Rousseau, Clinton Township, MI (US); Hamid G. Kia, Bloomfield Hills, MI (US)

(21) Appl. No.: 15/248,072

(22) Filed: Aug. 26, 2016

(51) Int. Cl. B29C 59/16

(52) U.S. Cl. CPC B29C 59/16

(57) ABSTRACT

An ultrasonic tooling system for texturing a workpiece includes a horn having an end portion forming an interface with the surface of the workpiece. The end portion of the horn has a texture formed thereon. As a result of a high frequency ultrasonic vibration, the surface of the workpiece takes on a mirror image of the texture of the end portion of the horn. Alternately, the texture may be formed on an anvil and wherein, as a result of a lower frequency ultrasonic vibration, the surface of the workpiece corresponding to the anvil takes on a mirror image of the texture of the upper surface of the anvil.

### FIELD

The present disclosure relates to surface texturing of materials with an ultrasonic tool.

### INTRODUCTION

The statements in this section merely provide background information related to the present disclosure and may not constitute prior art.

In many applications, polymeric and composite parts incorporate textured surfaces for visual or haptic benefits. Surface texturing can take the form of random or geometric patterning. The patterning style is formed onto a surface of a molding tool (e.g., through chemical etching or CNC machining). The molding tool is then used during part forming such that a mirror image of the surface texture appears on the molded part surface. In order to change patterning on a part, new molding tools must be manufactured.

### SUMMARY

An ultrasonic tooling system for texturing a workpiece includes a horn having an end portion forming an interface with a surface of the workpiece. The end portion of the horn has a texture formed there on. As a result of a high frequency ultrasonic vibration, the surface of the workpiece takes on a mirror image of the texture of the end portion of the horn.

An ultrasonic tooling system for texturing a workpiece having a first surface and an opposing second surface includes an anvil and a horn. The anvil has an upper surface forming an interface with the first surface of the workpiece. The upper surface of the anvil has a texture formed thereon. The horn has a lower surface forming an interface with the second surface of the workpiece. Furthermore, as a result of a low frequency ultrasonic vibration, the first surface of the workpiece takes on a mirror image of the texture of the upper surface of the anvil.

An ultrasonic tooling system for texturing a workpiece having a first surface and an opposing second surface includes an anvil and a horn. The horn is arranged at the first surface of the workpiece. The anvil is arranged at the second surface of the workpiece. The anvil further includes a plurality of movable pins arranged so as to provide a predetermined surface texture for the anvil. Furthermore, as a result of a low frequency ultrasonic vibration, the first surface of the workpiece takes on a mirror image of the predetermined surface texture of the anvil.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of an exemplary ultrasonic tooling system according to the present disclosure;

FIG. 2A is a schematic view of another exemplary ultrasonic tooling system having a textured horn according to the present disclosure;

FIG. 2B is a perspective view of the textured horn of FIG. 2A depicting the textured surface;

FIG. 3A is a schematic view of another exemplary ultrasonic tooling system having a textured anvil according to the present disclosure;

FIG. 3B is a perspective view of the textured anvil of FIG. 3A depicting the textured surface;

FIG. 4A is a schematic view of a reconfigurable anvil according to the present disclosure having movable pins arranged in a first position; and

FIG. 4B is a schematic view of the reconfigurable anvil of FIG. 4A having movable pins arranged in a second position.

### DETAILED DESCRIPTION

The following description is merely exemplary in nature and is not intended to limit the present disclosure, application, or uses. It should be understood that throughout the drawings, corresponding reference numerals indicate like or corresponding parts and features. Further, directions such as “top,” “side,” “back”, “lower,” and “upper” are used for purposes of explanation and are not intended to require specific orientations unless otherwise stated. These directions are merely provided as a frame of reference with respect to the examples provided, but could be altered in alternate applications.

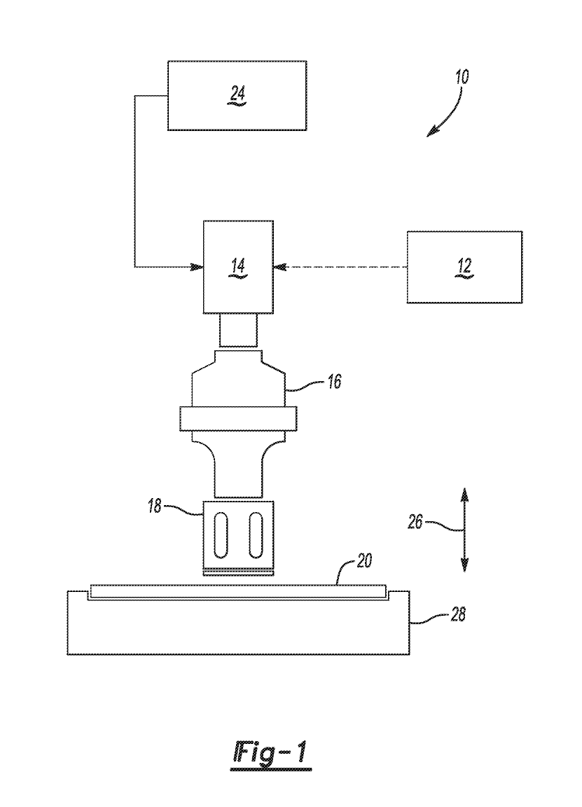

Referring now to FIG. 1, an exemplary ultrasonic tooling system 10 is shown having a power supply 12 for converting line power (e.g., low-frequency electrical signal of about 50-60 Hz) to a high frequency, high voltage electrical signal (e.g., 15-70 kHz, and more particularly 20-40 kHz). The high frequency electrical signal is then converted to a mechanical vibration at an ultrasonic frequency in a converter (i.e., transducer) 14. An optional booster 16 may be included in the system 10 in order to amplify the mechanical vibration such that the vibration amplitude can be increased. The ultrasonic vibrations then propagate through the horn or sonotrode 18. The tip of the horn 18 can then focus the ultrasonic vibration and deliver the vibration energy to a specified area on a material (e.g., at a portion of workpiece 20). The ultrasonic tooling system 10 also includes a tool positioning system 24 for moving the horn 18 in a direction perpendicular to the workpiece 20 (e.g., in direction of arrow 26) in order to apply a selected normal force (e.g., through air pressure supplied by a pneumatic piston or, alternatively, via an electric servo motor) to the workpiece 20 during the ultrasonic process for applying a welding pressure thereto. The workpiece 20 may be arranged upon an anvil or nest 28 for support during the ultrasonic process. In some embodiments, however, the workpiece 20 may have enough inherent strength to support the process without the need for the anvil 28.

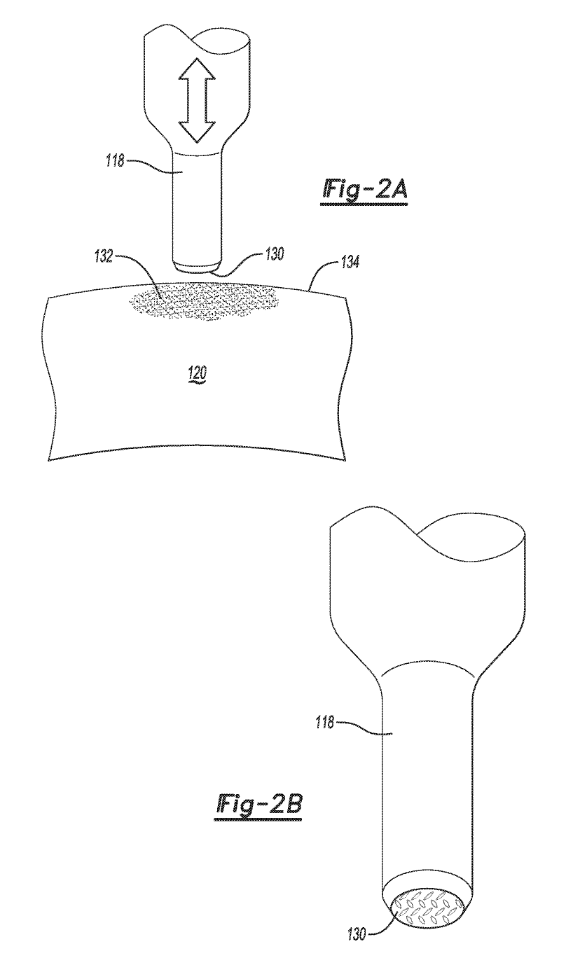

With reference to FIGS. 2A and 2B, an exemplary ultrasonic horn 118 may include a textured lower surface 130. The texture on the lower surface 130 of the horn 118 may be a random configuration or may be a geometric pattern, such as shown in FIG. 2B. The textured lower surface 130 of the horn 118 may interact with a workpiece 120. The workpiece 120 may be flat or may be curved as shown in FIG. 2A. The workpiece 120 may be supported by an anvil or may have enough inherent strength to support the ultrasonic processing on its own. During high frequency operation (e.g., 15 KHz to 70 KHz, preferably 40 to 70 KHz), the horn 118 will provide high frequency vibration at an interface 132 between the workpiece 120 and the horn 118. This vibration will result in heat generation and localized melting of the workpiece 120, such that the workpiece 120 is amenable to conforming to the textured lower surface 130 of the horn 118. In this way, an upper surface 134 of the workpiece 120 can be locally textured according to a design intent. Modifying the surface texture of the workpiece 120 to another design can be achieved by merely exchanging the horn 118 having the textured lower surface 130 to a horn having an alternate surface texture and/or footprint dimension.

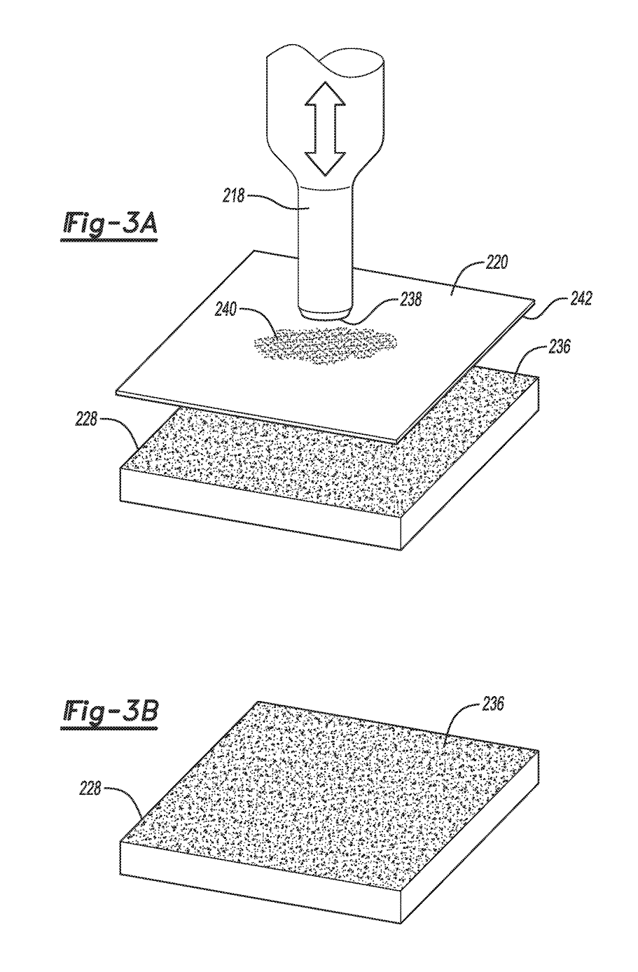

With reference to FIGS. 3A and 3B, an exemplary anvil 228 may include a textured upper surface 236. The texture on the upper surface 236 of the anvil 228 may be a random configuration, such as shown in FIG. 3B, or may be a geometric pattern. The textured upper surface 236 of the anvil 228 may interact with a workpiece 220 arranged thereon. During low frequency operation (e.g., from 15 to 70 KHz, preferably, 15 to 30 KHz), a horn 218 having a flat lower surface 238 will provide low frequency vibration to the workpiece 220. This vibration will result in heat generation and localized melting of the workpiece 220 at an interface 240 between the workpiece 220 and the textured upper surface 236 of the anvil 228. As such, the workpiece 220 is amenable to conforming to the textured upper surface 236 of the anvil 228. In this way, a lower surface 242 of the workpiece 220 can be locally textured according to a design intent. Modifying the surface texture to another design can be achieved by merely exchanging the anvil 228 having the textured upper surface 236 to an anvil having an alternate surface texture.

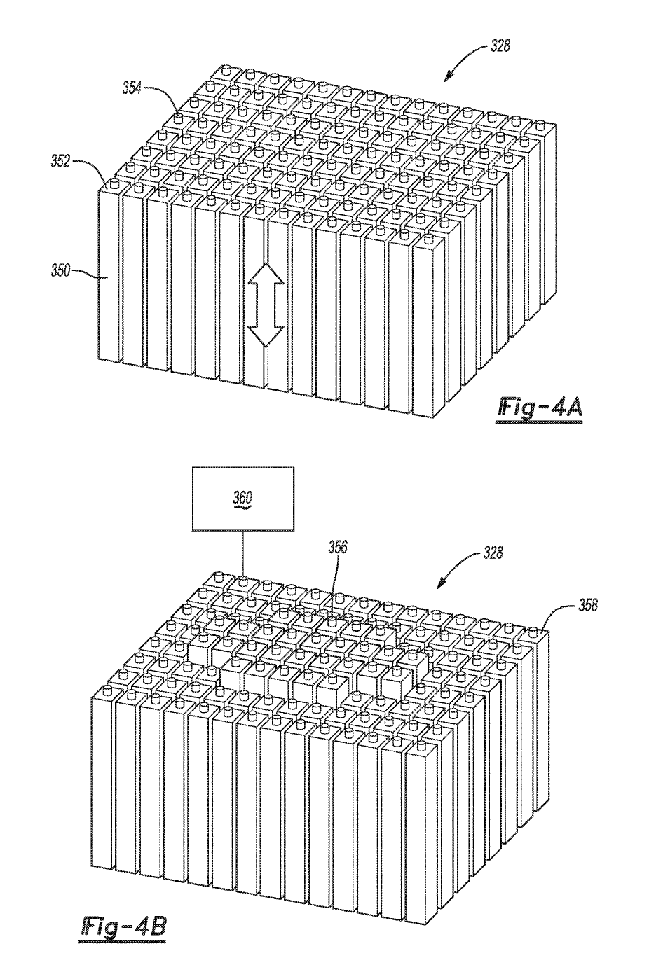

Referring now to FIGS. 4A and 4B, an exemplary anvil 328 is shown including a plurality of movable pins 350. Each movable pin 350 has an upper surface 352 with a shaped feature 354 arranged thereon to direct the vibration energy of the ultrasonic system. The pins 350 can be extended or, alternatively, retracted from the anvil 328 to provide a desired texture design image. For example as shown in FIG. 4B, selected pins 356 are extended upwardly from unselected pins 358 so as to form a bowtie image. Movement of the selected pins 356 can be performed electromechanically under direction from a controller 360 (e.g., through selected X-, Y-, or Z-coordinates) or can be performed by mating the anvil 328 with a mold template (not shown). The mold template can provide a mirror image of the final required configuration of the anvil 328 and can be placed over the plurality of movable pins 350 such that the shaped features 354 on the upper surface 352 mate with a surface of the mold template to achieve a desired configuration. Alternately, the mold template can provide a duplicate image to the final required configuration of the anvil 328. The mold template can then be placed under the plurality of movable pins 350 such that selected pins 356 are extended upwardly from unselected pins 358 to achieve the desired configuration. The anvil 328 alters the surface of a workpiece in a similar way to that described with reference to FIGS. 3A and 3B, and thus will not be repeated herein. Modifying the surface texture of the workpiece to another design can be achieved by merely moving the pins 350 to display an alternate surface arrangement. In this way, the anvil 328 is quickly reconfigurable to provide alternate surface textures and images.

Each of the aforementioned surface texturing techniques enables the texturing and graining of polymeric and composite parts post-molding through the use of ultrasonic tooling systems. Texturing of upper or lower surfaces of a workpiece can be accomplished by providing a surface treatment to either the horn or anvil of the tool and by appropriately selecting the tool frequency (e.g., high- or low-level frequency range). In this way, manufacturing flexibility can be gained as there is no need to add graining to the molding tooling. The molding tooling can provide a generic shape with product and/or brand differentiation of the final product easily accomplished through a secondary processing step. Additionally, individual parts may be customized by the addition of logos and/or personalization. Further, the ultrasonic manufacturing operation is relatively fast (e.g., between 0.5 to 10 seconds) making it very efficient from a manufacturing standpoint. The ultrasonic tooling system, as described herein, may be beneficial for use in the automotive and aerospace manufacturing industries; the toy and consumer products industries; the agricultural, military, appliance, construction, food and beverage, and medical service industries; and general manufacturing applications.

Embodiments of the present disclosure are described herein. This description is merely exemplary in nature and, thus, variations that do not depart from the gist of the disclosure are intended to be within the scope of the disclosure. For example, the exemplary ultrasonic tooling system 10 shown in FIG. 1 represents only one example of a source of ultrasonic mechanical energy that may be used according to the embodiments disclosed herein. As such, it should be understood that any suitable ultrasonic vibration apparatus may be employed to practice the disclosed embodiments.

Furthermore, the figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for various applications. Various combinations and modifications of the features consistent with the teachings of this disclosure, however, could be desired for particular applications or implementations and are deemed to be within the scope of this disclosure.

What is claimed is:

1. An ultrasonic tooling system for texturing a workpiece, comprising:
a horn having an end portion forming an interface with a surface of the workpiece, the end portion of the horn having a texture formed thereon; wherein, as a result of a high frequency ultrasonic vibration, the surface of the workpiece takes on a mirror image of the texture of the end portion of the horn.

2. The ultrasonic tooling system of claim 1, wherein the texture of the end portion of the horn is a random configuration.

3. The ultrasonic tooling system of claim 1, wherein the texture of the end portion of the horn is a geometric configuration.

4. The ultrasonic tooling system of claim 1, wherein the high frequency ultrasonic vibration is at the magnitude of 15-70 kHz.

5. The ultrasonic tooling system of claim 4, wherein the high frequency ultrasonic vibration is at the magnitude of 40 to 70 kHz.

6. An ultrasonic tooling system for texturing a workpiece having a first surface and an opposing second surface, comprising:
an anvil having an upper surface forming an interface with the first surface of the workpiece, the upper surface of the anvil having a texture formed thereon; and
a horn having a lower surface forming an interface with the second surface of the workpiece; wherein, as a result of a low frequency ultrasonic vibration, the first surface of the workpiece takes on a mirror image of the texture of the upper surface of the anvil.

7. The ultrasonic tooling system of claim 6, wherein the texture of the upper surface of the anvil is a random configuration.

8. The ultrasonic tooling system of claim 6, wherein the texture of the upper surface of the anvil is a geometric configuration.

9. The ultrasonic tooling system of claim 6, wherein the low frequency ultrasonic vibration is at the magnitude of 15-70 kHz.

10. The ultrasonic tooling system of claim 9, wherein the low frequency ultrasonic vibration is at the magnitude of 15 to 30 kHz.

11. An ultrasonic tooling system for texturing a workpiece having a first surface and an opposing second surface, comprising:
a horn arranged at the first surface of the workpiece; and
an anvil arranged at the second surface of the workpiece, wherein the anvil includes a plurality of movable pins arranged so as to provide a predetermined surface texture for the anvil, and wherein as a result of a low frequency ultrasonic vibration, the first surface of the workpiece takes on a mirror image of the predetermined surface texture of the anvil.

12. The ultrasonic tooling system of claim 11, wherein the texture of the upper surface of the anvil is a random configuration.

13. The ultrasonic tooling system of claim 11, wherein the texture of the upper surface of the anvil is a geometric configuration.

14. The ultrasonic tooling system of claim 11, wherein the low frequency ultrasonic vibration is at the magnitude of 15-70 kHz.

15. The ultrasonic tooling system of claim 14, wherein the low frequency ultrasonic vibration is at the magnitude of 15 to 30 kHz.

16. The ultrasonic tooling system of claim 11, wherein each movable pin has an upper surface with a shaped feature arranged thereon.

17. The ultrasonic tooling system of claim 16, wherein at least one movable pin is extended from or retracted into the anvil to provide the predetermined surface texture for the anvil.

18. The ultrasonic tooling system of claim 17, wherein movement of the at least one movable pin is performed electromechanically by a controller based on a predetermined surface texture.

19. The ultrasonic tooling system of claim 17, wherein movement of the at least one movable pin is performed by mating the anvil with an inverse mold template.

20. The ultrasonic tooling system of claim 11, wherein the anvil is reconfigurable to provide a plurality of predetermined surface textures for the anvil.
